(19) United States
(12) Patent Application Publication
(10) Pub. No.: US 2015/0316917 A1
(43) Pub. Date: Nov. 5, 2015

(54) CONTROLLER THAT OUTPUTS SWITCHOVER NOTIFICATION SIGNAL UPON SWITCHING OF SEQUENCE PROGRAM

(71) Applicant: FANUC Corporation, Minamitsuru-gun (JP)

(72) Inventors: Akihiro MATSUMOTO, Minamitsuru-gun (JP); Satoshi HASEGAWA, Minamitsuru-gun (JP); Noritake NAGASHIMA, Minamitsuru-gun (JP)

(21) Appl. No.: 14/676,870

(22) Filed: Apr. 2, 2015

(30) Foreign Application Priority Data
Apr. 30, 2014 (JP) 2014-094089

(51) Int. Cl. G05B 19/042

(52) U.S. Cl. CPC G05B 19/042; G05B 2219/25315

(57) ABSTRACT

After obtaining a switchover request that causes a sequence program in execution to be switched to another one, the controller turns ON a signal that notifies the sequence program in execution of its switchover. Then, after repetitively executing the sequence program in execution a predetermined number of times, the controller turns OFF the signal, and then switches the sequence program in execution to a designated sequence program.

### BACKGROUND OF THE INVENTION

1. Field of the Invention

The present invention relates to a controller that outputs a switchover notification signal upon switching of a sequence program.

2. Description of the Related Art

Controllers such as programmable controllers periodically and repetitively execute a sequence program to control a machine. When a sequence program is debugged or maintenance work is performed on a machine, a programmable controller often switches the program while operating the machine without stopping it. In order to edit or update the sequence program while the machine is operating, various systems have been considered.

A system that allows a sequence program to be updated while a machine is operating is disclosed in Japanese Patent Application Laid-Open No. 02-005103. In this system, a plurality of sequence programs is stored in a storage section. While one of these sequence programs is being executed, another one is edited. After the sequence program has been edited, the sequence program in execution is switched to the edited sequence program.

Next, with reference to a flow chart shown in FIG. 8, a sequence program switchover process according to related art will be described.

While a controller is executing a sequence program 1 (step S801), when the sequence program 1 is ready to be switched to a sequence program 2, the controller is notified of a sequence program switchover request and information that designates the sequence program 2 as the update program from the outside of the controller through an external device 30, an MDI unit (manual data input unit) 50, or the hike (step S802). As a result, the controller switches the program in execution to the sequence program 2 (step S803).

When the sequence program in execution is switched to another one again, the foregoing procedure is performed. In other words, while the controller is executing the sequence program. 2 (step S803), when the sequence program 2 is ready to be switched to the sequence program 1, the controller is notified of a sequence program switchover request and information that designates the sequence program 1 as the update program from the outside of the controller through the external device 30, the MDI unit 50, or the like (step S804). As a result, the controller switches the sequence program in execution to the sequence program 1 (step S801).

FIG. 9 is a timing chart showing the execution states of the sequence program 1 and the sequence program 2 in the system according to the related art reference. In the timing chart, the horizontal axis represents a time axis. The time axis is divided by broken lines into individual execution cycles of the sequence programs executed by the controller. In the timing chart, thick arrows represent individual execution cycles of the sequence programs.

In the system according to the related art, while the controller is executing the sequence program 1, when the controller obtains a sequence program switchover request from the outside of the controller, the controller switches the sequence program in execution to the sequence program 2 at the end of the current execution cycle of the sequence program 1.

The system according to the related art reference allows a sequence program to be edited and/or updated while a machine is operating. However, since this system causes a sequence program in execution to be instantaneously switched to another one while a machine is operating, if the edited program has a problem or the sequence program in execution is switched to an unexpected one, the machine may operate in an unexpected manner. Thus, before the sequence program in execution is switched to another one, the operator needs to take appropriate countermeasures, for example, he or she needs to manually perform an emergency stop operation for the machine to prevent a hazard situation from occurring even if the machine operates in an unexpected manner. Thus, if the sequence program in execution is switched to another one when the operator forgets to perform the manual emergency stop operation for the machine, an unexpected hazard situation such as operator's injury and/or machine's damage likely occurs.

### SUMMARY OF THE INVENTION

Therefore, an object of the present invention is to provide a controller that incorporates a process that prevents a hazard situation from occurring, including a process that brings a machine to an emergency stop state, for example, when an operator edits and/or updates a sequence program for debugging of the sequence program or for maintenance work for the machine so that the process is automatically executed when the sequence program is switched to another one, thereby enabling a hazard situation due to the operator's carelessness to be prevented from occurring and allowing the operator to dedicatedly debug the sequence program or perform maintenance work for the machine.

A controller according to the present invention has a signal memory from and to which a sequence program is read and written and a sequence program storage memory that stores a plurality of sequence programs, and the controller repetitively executes one of the plurality of sequence programs stored in the sequence program storage memory.

A first aspect of the controller according to the present invention also includes a switchover request/execution designation information obtaining section that obtains a sequence program switchover request and sequence program execution designation information from the outside of the controller, the sequence program switchover request causing the sequence program in execution to be switched to another one, and the sequence program execution designation information designating one of the sequence programs stored in the sequence program storage memory as a sequence program to be executed after the switchover; a notification signal setting section that turns ON a sequence program switchover notification signal that notifies the sequence program in execution of its switchover to another one after the switchover request/execution designation information obtaining section has obtained the sequence program switchover request and the sequence program execution designation information; and an execution switchover section that, after repetitively executing the sequence program in execution a predetermined number of times, turns OFF the sequence program switchover notification signal that has been turned ON by the notification signal setting section, and switches the sequence program in execution to the sequence program designated by the sequence program execution designation information.

The controller may also include a repetitive execution number-of-times designation section that designates the number of times the sequence program in execution is repetitively executed, for turning OFF the sequence program switchover notification signal.

A second aspect of the controller according to the present invention also includes a switchover request/execution designation information obtaining section that obtains a sequence program switchover request and sequence program execution designation information from the outside of the controller, the sequence program switchover request causing the sequence program in execution to be switched to another one, and the sequence program execution designation information designating one of the sequence programs stored in the sequence program storage memory as a sequence program to be executed after the switchover; a notification signal setting section that turns ON a sequence program switchover notification signal that notifies the sequence program in execution of its switchover to another one after the switchover request/execution designation information obtaining section has obtained the sequence program switchover request and the sequence program execution designation information; a setting detection section that detects that a sequence program switchover permission signal that is stored in the signal memory and permits a sequence program to be switched to another one has been turned ON by the sequence program in execution; and an execution switchover section that turns OFF the sequence program switchover notification signal that has been turned ON by the notification signal setting section and switches the sequence program in execution to the sequence program designated by the sequence program execution designation information when the setting detection section detects that the sequence program switchover permission signal has been turned ON.

The first aspect and the second aspect of the controller according to the present invention may include an edit section that causes control software to edit the sequence programs stored in the sequence program storage memory; and a storage section that inputs sequence programs from an external device and stores the sequence programs in the sequence program storage memory.

According to the present invention, process that prevents a hazard situation from occurring when an operator edits and/or updates a sequence program for debugging of the sequence program or for maintenance work for the machine is incorporated in the sequence program so that the process is automatically executed when the sequence program is switched to another one, thereby enabling a hazard situation due to the operator's carelessness to be prevented from occurring and allowing the operator to dedicatedly debug the sequence program or perform a maintenance work for the machine.

### BRIEF DESCRIPTION OF THE DRAWINGS

The above and other objects and features of the present invention will be apparent from the following description of embodiments with reference to the accompanying drawings, in which:

FIG. 1 is a block diagram showing an outline of a controller according to an embodiment of the present invention;

FIG. 2 is a flow chart showing a first example of a sequence program switchover process of the controller shown in FIG. 1;

FIG. 3 is a flow chart showing a process executed by the sequence program 1 and the sequence program 2 in the first example of the sequence program switchover process;

FIG. 4 is a timing chart showing the sequence program switchover operation in the first example of the sequence program switchover process;

FIG. 5 is a flow chart showing a second example of the sequence program switchover process of the controller shown in FIG. 1;

FIG. 6 is a flow chart showing a process executed by the sequence program 1 and the sequence program 2 in the second example of the sequence program switchover process;

FIG. 7 is a timing chart showing the sequence program switchover operation in the second example of the sequence program switchover process;

FIG. 8 is a flow chart showing a sequence program switchover operation according to a related art; and

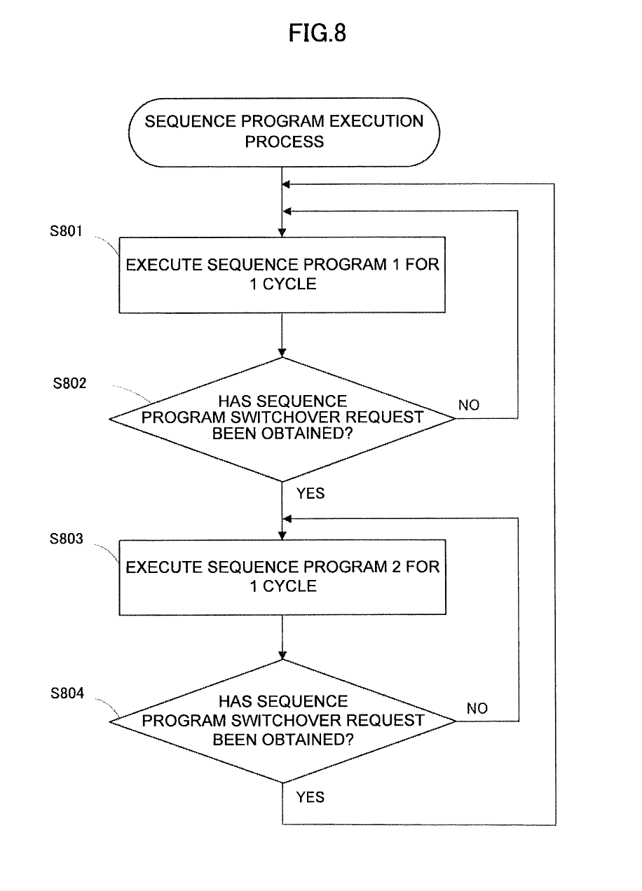

FIG. 9 is a timing chart showing the sequence program switchover operation according to the related art.

### DESCRIPTION OF THE PREFERRED EMBODIMENTS

Next, with reference to a block diagram shown in FIG. a controller according to an embodiment of the present invention will be described below.

A controller 10 includes a CPU 11, a ROM 12, a RAM 13, a nonvolatile memory 14, an external storage medium interface 15, an external interface 16, a display controller 17, an MDI controller 18, and an external signal interface 19.

The CPU 11 is a processor that controls the whole of the controller 10. The CPU 11 reads a system program from the ROM 12 and controls the whole of the controller 10 according to the system program that is read from the ROM 12.

Pre-stored in the ROM 12 are a program that manages the memory and various system programs that execute a process for an edit mode in which a machining program is created and edited and a process for an automatic operation.

Stored in the RAM 13 are data that are input through the external storage medium interface 15/external interface 16/external signal interface 19 or through the MDI unit 50 and that are necessary for individual blocks to perform their functions. In addition, stored in the RAM 13 are temporary calculation data and so forth. Moreover, allocated in the RAM 13 are a signal memory that simultaneously stores a plurality of signals used by the system programs in managing the state of the control device and a memory region that stores a plurality of sequence programs.

The nonvolatile memory 14 is backed up with a battery (not shown) and is configured as a nonvolatile memory in which. data are held even if a power source of the controller 10 is turned off. The external storage medium interface 15 is connected with an external storage medium 20 so as to input and output data necessary for each process to and from the external storage medium 20. The external interface 16 is connected with an external device 30 such as a sequence program development support device or the like so as to input and output sequence programs and so forth to and from the external device 30.

The display controller 17 is connected with an information presentation unit 40 such as a display so as to control display of data to be supplied to the operator. The MDI controller 18 is connected with an MDI unit 50 such as a keyboard so as to control data that the operator manually inputs. The external signal interface 19 is connected with an I/O device 60 so as to control input and output of I/O signals.

The controller 10 pre-stores a sequence program 1 and a sequence program 2 in the RAM 13. The sequence program 1 is an executing program that the controller 10 is executing when it starts the sequence program switchover process. On the other hand, the sequence program 2 is an update program that is switched from the sequence program 1 when the sequence program switchover process is executed.

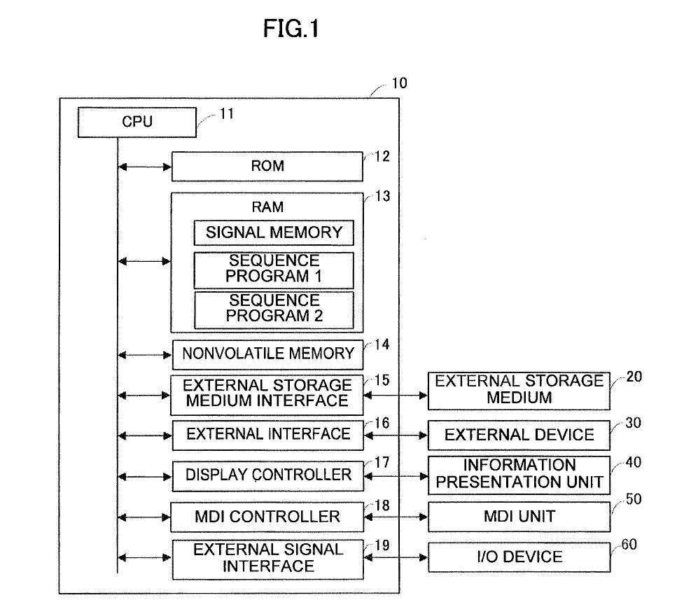

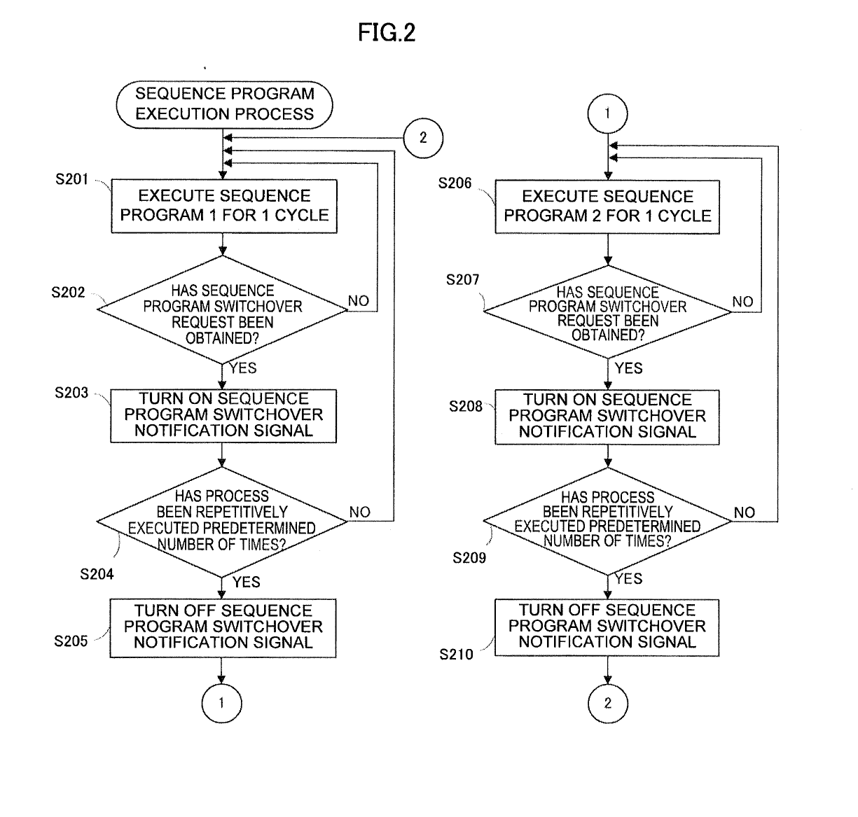

First, with reference to FIG. 2 to FIG. 4, a first example of the sequence program switchover process executed by the controller shown in FIG. 1 will be described.

With reference to a flow chart shown in FIG. 2, the sequence program switchover process executed by the controller 10 will be described.

While the controller 10 is executing the sequence program 1 (step S201), when the sequence program 1 is ready to be switched to the sequence program 2, the controller 10 is notified of a sequence program switchover request and information that designates the sequence program 2 as the update program from the outside of the controller 10 through an external device 30, an MDT unit 50, or the like.

When the controller 10 obtains the sequence program switchover request and the information that designates the sequence program (step S202), the controller 10 turns ON a sequence program switchover notification signal stored in the signal memory (step S203).

After controller 10 turns ON the sequence program switchover notification signal, the controller 10 repetitively executes the sequence program 1 a predetermined number of times (step S204). At this point, the sequence program 1 executes a process that causes the machine to enter into a safe mode.

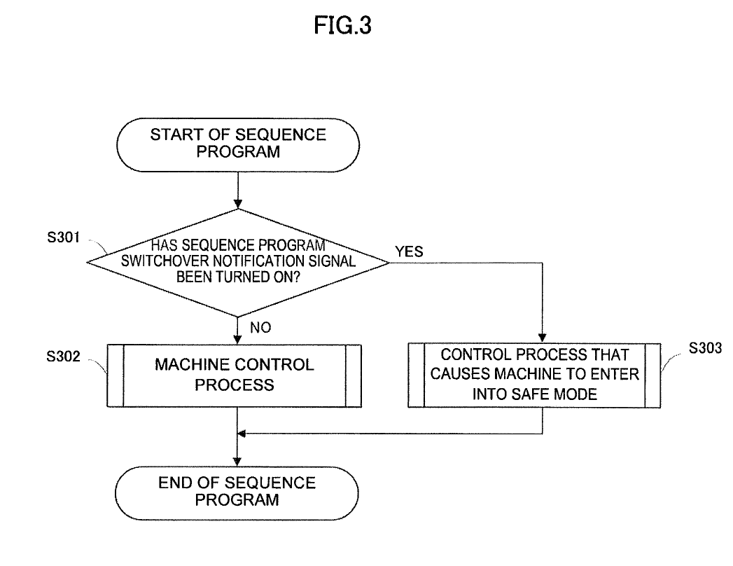

Next, with reference to a flow chart shown in. FIG. 3, a process executed by the sequence program 1 and the sequence program 2 will be described.

When the sequence program switchover notification signal has been turned OFF in step S301, the sequence program 1 and the sequence program 2 execute a regular machine control process (step S302). In contrast, when it is detected that the sequence program switchover notification signal has been turned ON in step S301, the sequence program 1 and the sequence program 2 execute the process that causes the machine to enter into the safe mode (step S303).

Returning to FIG. 2, after the controller 10 repetitively executes the sequence program 1 a predetermined number of times, the controller 10 turns OFF the sequence program switchover notification signal (step S205) and then switches the sequence program in execution to the sequence program 2 (step S206).

When the controller 10 switches the sequence program in execution to another one again, the controller 10 executes the foregoing procedure. In other words, while the controller 10 is executing the sequence program 2 (step S206), when the sequence program 2 is ready to be switched to the sequence program 1, the controller 10 is notified of the sequence program switchover request and the information that designates the sequence program 1 as the update program from the outside of the controller 10 through the external device 30, the MDI unit 50, or the like.

When the controller 10 obtains the sequence program switchover request and the information that designates the sequence program (step S207), the controller 10 turns ON the sequence program switchover notification signal stored in the signal memory (step S208).

After the controller 10 turns ON the sequence program switchover notification signal, the controller 10 repetitively executes the sequence program 2 a predetermined number of times (step S209), turns OFF the sequence program switchover notification signal (step S210), and then switches the sequence program in execution to the sequence program 1 (step S201).

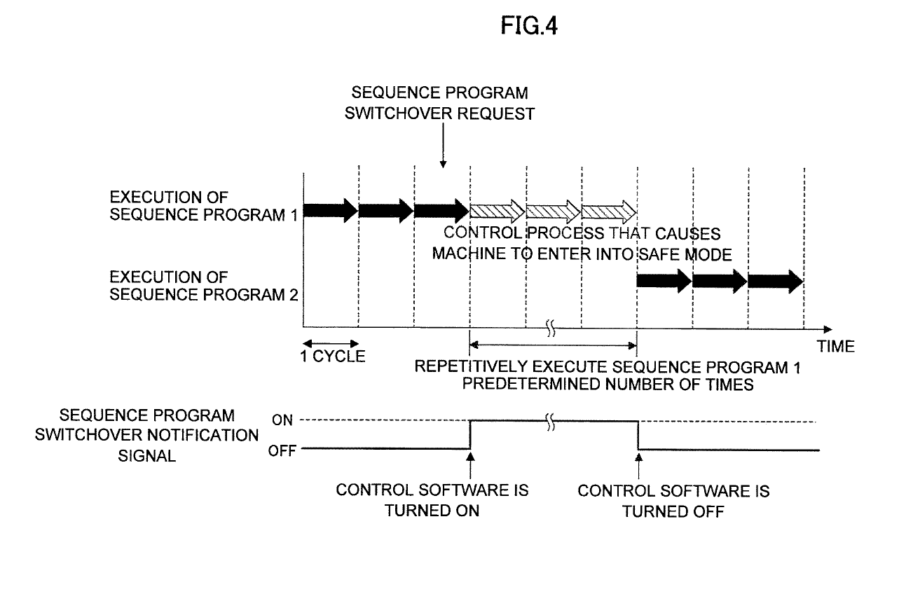

Next, with reference to a timing chart shown in FIG. 4, the execution states of the sequence program. 1 and the sequence program 2 will be described.

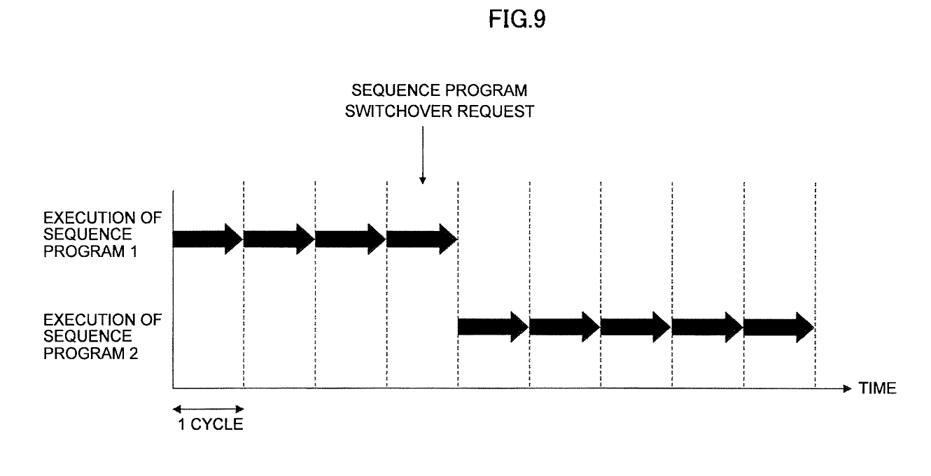

In the timing chart shown in FIG. 4, like the timing chart shown in FIG. 9, the horizontal, axis represents a time axis. The time axis is divided by broken lines into individual execution cycles of sequence programs. In the timing chart, thick arrows represent individual execution cycles of a machine control process of a sequence program. In addition, hatched thick arrows represent individual execution cycles of a control process that causes the machine to enter into the safe mode, the control process being executed by a sequence program. Moreover, shown below the time axis on the execution states of the sequence programs is the state of the sequence program switchover notification signal.

While the controller 10 is executing the sequence program 1, when the controller 10 obtains the sequence program switchover request from the outside of the controller 10 through any interface, the sequence program switchover notification signal is turned ON at the end of the current execution cycle of the sequence program 1. In response, in the next cycle, the sequence program 1 starts executing the process that causes the machine to enter into the safe mode. After the controller 10 executes the sequence program 1 the predetermined number of times, the machine enters into the safe mode where the controller can switch the sequence program in execution to another one. Thereafter, the controller 10 turns OFF the sequence program switchover notification signal and then switches the sequence program in execution to the sequence program 2.

Thus, in the first example of the sequence program switchover process executed by the controller 10, when the operator updates the sequence program, after the sequence program executes the process that causes the machine to enter into the safe mode and a sufficient period of time elapses, the controller 10 switches the sequence program in execution to another one. As a result, the operator can update the sequence program without need to consider the safety of the machine.

“A predetermined number of times”, by which the controller 10 repetitively executes the sequence program 1 and the sequence program 2 after the sequence program switchover notification signal is turned ON in steps S204 and S209 of the flow chart shown in FIG. 2, may be a number of times that is sufficient for the sequence program 1 and the sequence program 2 to cause the machine to enter into the safe mode and is designated by designation means, or may be a fixed number.

In the foregoing example, the number of sequence programs is two. Even if three or more sequence programs are stored in the storage memory, the sequence program switchover process can be accomplished by the similar means.

Alternatively, a structure that allows the sequence program in execution to be edited on the controller 10 while the machine is operating for updating the sequence program may be provided. Further alternatively, a structure that allows a sequence program to be input through an external device such as a sequence program development support device may be provided.

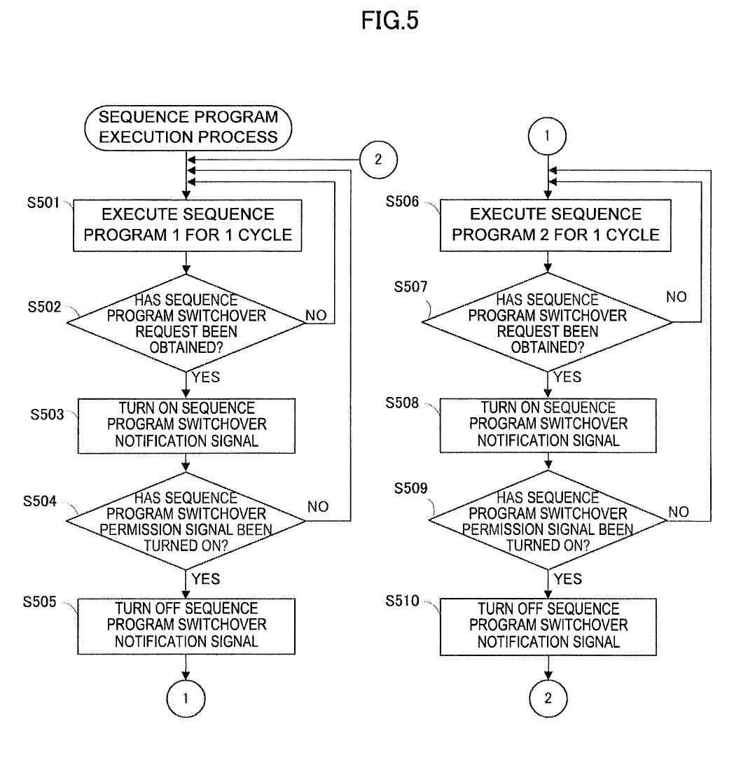

Next, with reference to FIG. 5 to FIG. 7, a second example of the sequence program switchover process executed by the controller shown in FIG. 1 will be described.

In the first example of the foregoing sequence program switchover process, a sequence program is executed a predetermined number of times so that the machine enters into the safe mode and a sufficient period of time elapses. In contrast, in the second example of the sequence program switchover process, a sequence program switchover permission signal is stored in the signal memory of the RAM 13 along with the sequence program switchover notification signal, and the sequence program in execution is switched to another one based. on the sequence program switchover permission signal.

The hardware structure of the controller that executes the second example of the sequence program switchover process is the same as that shown in FIG. 1. The controller 10 pre-stores a sequence program 1 as an executing program and a sequence program 2 as an update program in the RAM 13.

Next, with reference to a flow chart shown in FIG. 5, the sequence program switchover process executed by the controller 10 will be described.

While the controller 10 is executing the sequence program 1 (step S501), when the sequence program 1 is ready to be switched to the sequence program 2, the controller 10 is notified of a sequence program switchover request and information that designates the sequence program 2 as the update program from the outside of the controller 10 through an external device 30, an MDI unit 50, or the like.

When the controller 10 obtains the sequence program switchover request and the information that designates the sequence program (step S502), the controller 10 turns ON the sequence program switchover notification signal stored in the signal memory (step S503).

Thereafter, while the controller 10 is monitoring the state of the sequence program switchover permission signal, the controller 10 continues to execute the sequence program 1. At this point, the controller 10 executes the process that causes the machine to enter into a safe mode.

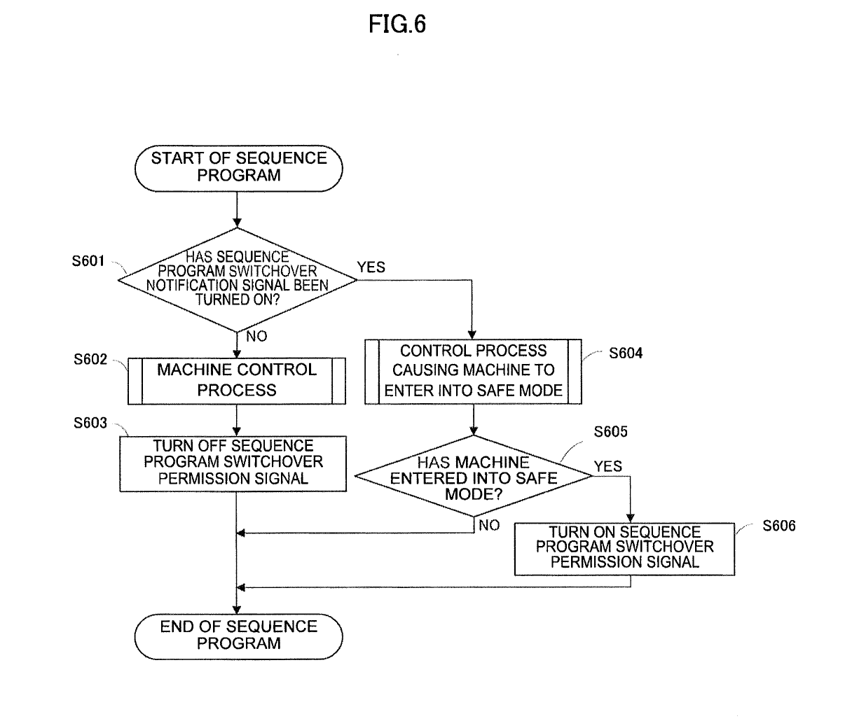

Next, with reference to a flow chart shown in FIG. 6, the process executed by the sequence program 1 and the sequence program 2 will be described.

When the sequence program switchover notification signal has been turned OFF in step S601, the sequence program 1 and the sequence program 2 execute a regular machine control process (step S602) and turn OFF the sequence program switchover permission signal stored in the signal memory (step S603). In contrast, when it is detected that the sequence program switchover notification signal has been turned ON in step S601, the sequence program 1 and the sequence program 2 execute the process that causes the machine to enter into the safe mode (step S604). When the machine has entered into the safe mode (step S605), the sequence program 1 and the sequence program 2 turn ON the sequence program switchover permission signal stored in the signal memory (step S606).

Returning to FIG. 5, the controller 10 monitors the state of the sequence program switchover permission signal. When the controller 10 has detected that the sequence program switchover permission signal has been turned ON (step S504), the controller 10 turns OFF the sequence program switchover notification signal (step S505) and then switches the sequence program in execution to the sequence program 2 (step S506).

When the sequence program is updated again, the foregoing procedure is executed again. In other words, while the controller 10 is executing the sequence program 2 (step S506), when the sequence program 2 is ready to be switched to the sequence program 1, the controller 10 is notified of the sequence program switchover request and the information that designates the sequence program 1 as the update program from the outside through the external device 30, the MDI unit 50, or the like.

When the controller 10 obtains the sequence program switchover request and the information that designates the sequence program (step S507), the controller 10 turns ON the sequence program switchover notification signal stored in the signal memory (step S508).

While the controller 10 is monitoring the state of the sequence program switchover permission signal, the controller 10 continues to execute the sequence program 2. When the controller 10 detects that the sequence program switchover permission signal has been turned ON (step S509), the controller 10 turns OFF the sequence program switchover notification signal (step S510) and then switches the sequence program in execution to the sequence program 1 (step S501).

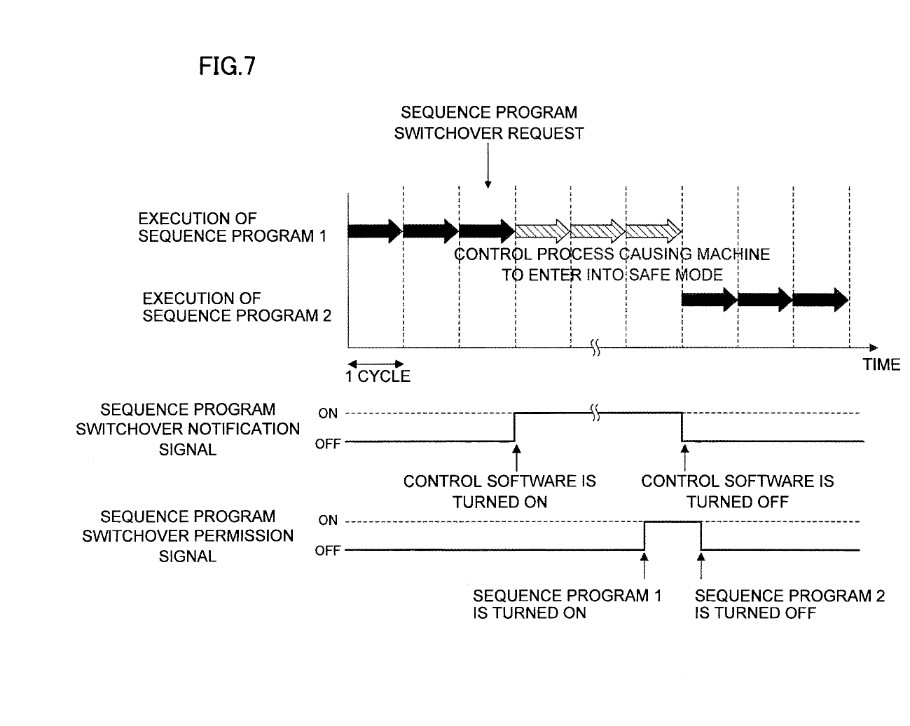

Next, with reference to a timing chart shown in FIG. 7, the execution states of the sequence program 1 and the sequence program 2 will be described.

In the timing chart shown in FIG. 7, like the timing chart shown in FIG. 3, the horizontal axis represents a time axis. The time axis is divided by broken lines into individual execution cycles of sequence programs. In the timing chart, thick arrows represent individual execution cycles of a machine control process of the sequence programs. In addition, hatched thick arrows represent individual execution cycles of a control process that causes the machine to enter into the safe mode. Moreover, shown below the time axis representing the execution states of the sequence programs are the states of the sequence program switchover notification signal and the sequence program switchover permission signal.

While the controller 10 is executing the sequence program 1, when the controller 10 obtains the sequence program switchover request from the outside of the controller 10 through any interface, the sequence program switchover notification signal is turned ON at the end of the current execution cycle of the sequence program 1. In response to that, in the next cycle, the sequence program 1 starts executing the control process that causes the machine to enter into the safe mode. When the machine has entered into the safe state, the sequence program 1 turns ON the sequence program switchover permission signal. When the controller 10 detects that the sequence program switchover permission signal has been turned ON, the controller 10 turns OFF the sequence program switchover notification signal and then switches the program in execution to the sequence program 2.

When the operator updates a sequence program, the controller 10 updates the sequence program after the sequence program in execution causes the machine to enter into the safe state and permits the operator to update the sequence program in execution. Thus, the operator can update the sequence program in execution without need to consider the safety of the machine. When the second example of the sequence program switchover process is compared with the first example, since the former has an advantage over the latter in that the former does not need to have designated a sufficient number of times that the sequence program executes the process that causes the machine to enter into the safe state. The sequence program switchover notification signal and the sequence program switchover permission signal serve to allow the handshake between controller and the sequence programs.

1. A controller comprising:
a signal memory from and to which a sequence program is read and written; and
a sequence program storage memory that stores a plurality of sequence programs, wherein
the controller repetitively executes one of the plurality of sequence programs stored in the sequence program storage memory, and further comprises:
a switchover request/execution designation information obtaining section that obtains a sequence program switchover request and sequence program execution designation information from the outside of the controller, the sequence program switchover request causing the sequence program in execution to be switched to another one, and the sequence program execution designation information designating one of the sequence programs stored in the sequence program storage memory as a sequence program to be executed after the switchover;
a notification signal setting section that turns ON a sequence program switchover notification signal that notifies the sequence program in execution of its switchover to another one after the switchover request/execution designation information obtaining section has obtained the sequence program switchover request and the sequence program execution designation information; and
an execution switchover section that, after repetitively executing the sequence program in execution a predetermined number of times, turns OFF the sequence program switchover notification signal that has been turned ON by the notification signal setting section, and switches the sequence program in execution to the sequence program designated by the sequence program execution designation information.

2. The controller according to claim 1, further comprising:
a repetitive execution number-of-times designation section that designates the number of times the sequence program in execution is repetitively executed, for turning OFF the sequence program switchover notification signal.

3. A controller comprising:
a signal memory from and to which a sequence program is read and written; and
a sequence program storage memory that stores a plurality of sequence programs, wherein
the controller repetitively executes one of the plurality of sequence programs stored in the sequence program storage memory, and further comprises:
a switchover request/execution designation information obtaining section that obtains a sequence program switchover request and sequence program execution designation information from the outside of the controller, the sequence program switchover request causing the sequence program in execution to be switched to another one, and the sequence program execution designation information designating one of the sequence programs stored in the sequence program storage memory as a sequence program to be executed after the switchover;
a notification signal setting section that turns ON a sequence program switchover notification signal that notifies the sequence program in execution of its switchover to another one after the switchover request/execution designation information obtaining section has obtained the sequence program switchover request and the sequence program execution designation information;
a setting detection section that detects that a sequence program switchover permission signal that is stored in the signal memory and permits a sequence program to be switched to another one has been turned ON by the sequence program in execution; and
an execution switchover section that turns OFF the sequence program switchover notification signal that has been turned ON by the notification signal setting section and switches the sequence program in execution to the sequence program designated by the sequence program execution designation information when the setting detection section detects that the sequence program switchover permission signal has been turned ON.

4. The controller according to claim 1,
further comprising:
an edit section that causes control software to edit the sequence programs stored in the sequence program storage memory; and
a storage section that inputs sequence programs from an external device and stores the sequence programs in the sequence program storage memory.

5. The controller according to claim 3,
further comprising:
an edit section that causes control software to edit the sequence programs stored in the sequence program storage memory; and
a storage section that inputs sequence programs from an external device and stores the sequence programs in the sequence program storage memory
